(19) United States
(12) Patent Application Publication
(10) Pub. No.: US 2007/0187316 A1
(43) Pub. Date: Aug. 16, 2007

(54) Oil filter assembly

(76) Inventors: Keith R. Weinberger, Randolph, NJ (US); Alan B. Johnson, Attleboro, MA (US); Mario A. Turchi, Tenafly, NJ (US); Robert Joachim, Glen Rock, NJ (US)

Correspondence Address: MCANDREWS HELD & MALLOY, LTD, 500 WEST MADISON STREET, SUITE 3400, CHICAGO, IL, 60661, US

(21) Appl. No.: 11/352,681

(22) Filed: Feb. 13, 2006

(51) Int. Cl. B01D 27/00

(52) U.S. Cl. 210/232; 210/440

(57) ABSTRACT

A fluid filter system includes a first segment and a second segment. The first segment includes a filter medium, a notch adapted to engage a detent, and a first actuation member. The second segment includes a detent engageable with the notch to secure the first segment to the second segment, and a second actuation member. The detent is moveable between a locked position and an unlocked position, and is normally biased into the locked position. The second actuation member is configured to cooperate with the first actuation member in order to move the detent between the locked and unlocked positions.

### BACKGROUND OF THE INVENTION

Embodiments of the present invention generally relate to a fluid filter assembly, such as an oil filter assembly, and more particularly to a fluid filter assembly that is configured to be quickly and easily changed.

A conventional oil filter assembly for an internal combustion engine typically includes a threaded end, which is rotated, twisted, or spun, onto a corresponding mounting structure of the engine. Once the assembly is mounted onto the engine, oil is circulated through the engine for filtering. Unfiltered oil from the engine is passed through a filtering medium, such as a pleated paper cylinder, of the assembly. As the unfiltered oil passes through the filtering medium, impurities contained within the oil are retained by the filter medium. Filtered oil is then passed back into the engine. Eventually, an oil filter assembly, or at least the filtering medium within the assembly, needs to be replaced due to the fact that it becomes clogged with numerous impurities, thereby diminishing its filtering ability.

Typical filters may be one-, two-, or three-part filters, depending on whether the parts of the filter can be disconnected from one another. In a one-part filter assembly, the filter medium is contained within a housing, and the entire filter assembly is screwed onto and off of an engine. When the filter medium is clogged, the entire filter assembly must be replaced.

A typical two-part filter assembly includes a casing and a base that threadably engage one another to form a housing around the filter medium. The base is affixed to a mounting structure of an engine or an oil pump assembly. For example, the base may be screwed onto a mounting stud of the engine. The casing, including the filter medium, may be removably secured, such as through threadable engagement, to the base, without removing the base from the engine. When the filter medium needs to be replaced, the casing is removed from the base, and a new casing is secured to the base.

A typical three-part filter assembly is similar to the two part filter assembly, except that the filter medium is separable from the rest of the assembly. As such, only the filter medium needs to be replaced, and the rest of the assembly may be reused with a new filter medium.

In order to change the filter medium in typical filters, one component is typically unscrewed from another component. The threads of, and/or other components (such as gaskets) located proximate to such threadable interfaces, are prone to sticking, which can pose difficulties in removing an oil filter from the engine (for a one-part filter assembly), or the casing from the base (for a two- or three-part filter assembly). Often, a specialized tool, such as an oil filter wrench, is required to remove the filter or casing from the engine. In many vehicles, however, the oil filter assembly is located at a position that is difficult to access. Thus, using a tool with some oil filters may be difficult.

Thus, a need exists for an oil filter assembly that is quick, clean, and easy to connect and disconnect from an engine. That is, a need exists for a system and method of quickly and efficiently changing an oil filter.

### SUMMARY OF THE INVENTION

Certain embodiments of the present invention provide a fluid filter system that includes a segment, such as a filter module, and an additional, separable segment, such as an adapter that is configured to be removably secured to a mounting stud of a device, such as an engine.

The filter module may include a main body that houses a filter medium, a circumferential notch formed at a lower end, and a first actuation member. The first actuation member may be a ring including a first set of teeth, wherein the first actuation ring is fixed within the filter module.

The adapter may include a generally cylindrical base integrally formed with an outer wall and a fluid outlet tube, wherein a fluid inlet cavity is defined between the outer wall and the fluid outlet tube, at least one detent, and a second actuation member. The detent may be a pawl engageable with the notch to secure the filter module to the adapter. The pawl is moveable between a locked position and an unlocked position, and is normally biased into the locked position. For example, the pawl may be spring-biased into the locked position. In the locked position, the pawl outwardly extends from the outer wall of the adapter, while the pawl recedes into the outer wall in the unlocked position.

The second actuation member may also be a ring moveably secured within the adapter and having a second set of teeth that mesh with the first set of teeth when the filter module is connected to the adapter. The first and second actuation rings cooperate to move the pawl into the unlocked position, wherein the filter module disconnects from the adapter when the pawl is in the unlocked position. In certain embodiments of the present invention, rotation of the first actuation ring causes a corresponding rotation in the second actuation ring. The rotation of the second actuation ring causes the second actuation ring to contact the pawl in order to move the pawl into the unlocked position.

The adapter may also include a coiled spring having one end secured to the second actuation ring and another end fixedly secured within the adapter. The coiled spring tends to keep the second actuation ring from contacting the pawl. Thus, the coiled spring tends to keep the pawl in the locked position, or allows the pawl to remain in the locked position.

The adapter may also include at least one anchor post extending from the base. The pawl may include a ramped end integrally formed with an intermediate section connected to a pivotable anchor member. The pivotable anchor member pivotally secures to the post and allows the second actuation ring to move the pawl between the locked and unlocked positions.

The filter module may also include an anti-drain valve positioned proximate a fluid inlet that sealingly engages the fluid outlet tube, an annular seal member sealingly engaging the outer wall, and a spring-biased drip seal plug positioned proximate a fluid outlet.

Certain embodiments of the present invention also provide a method of disconnecting an oil filter module from an adapter secured to a mounting stud of an engine. The method may include: (i) rotating the oil filter module relative to the adapter, wherein the rotating comprises rotating a module actuation member fixed within the filter module; (ii) causing an adapter actuation member movably secured within the adapter and mated to the module actuation member to rotate in response to the rotating the oil filter module step, (iii) moving the adapter actuation member into contact with a detent that is retained by a notch to secure the filter module to the adapter, (iv) disengaging the detent from the notch through the moving the adapter actuation member step, and (v) disconnecting the oil filter module from the adapter through the disengaging step, wherein the disconnecting step comprises removing the module actuation member from a mating position with the adapter actuation member. Removal of the oil filter module from the adapter may be facilitated by spring action.

### BRIEF DESCRIPTION OF SEVERAL VIEWS OF THE DRAWINGS

FIG. 1 illustrates a front view of a fluid filter assembly secured to a mounting stud of an engine according to an embodiment of the present invention.

FIG. 2 illustrates an isometric top view of an adapter according to an embodiment of the present invention.

FIG. 3 illustrates a bottom view of an adapter according to an embodiment of the present invention.

FIG. 4 illustrates a lateral view of an adapter according to an embodiment of the present invention.

FIG. 5 illustrates a cross-sectional view of an adapter through line 5-5 of FIG. 2 according to an embodiment of the present invention.

FIG. 6 illustrates an isometric top view of a lower actuation ring and pawls according to an embodiment of the present invention.

FIG. 7 illustrates a bottom view of a lower actuation ring and pawls according to an embodiment of the present invention.

FIG. 8 illustrates a partial side cross-sectional view of a filter module according to an embodiment of the present invention.

FIG. 9 illustrates a filter module in an initial mated position with respect to an adapter according to an embodiment of the present invention.

FIG. 10 illustrates a filter module in a fully mated position with respect to an adapter according to an embodiment of the present invention.

FIG. 11 illustrates a filter module being disconnected from an adapter according to an embodiment of the present invention.

FIG. 12 illustrates a cross-sectional view of an oil filter assembly secured to a mounting stud through line 12-12 of FIG. 1 according to an embodiment of the present invention.

FIG. 13 illustrates an isometric top view of an adapter according to an embodiment of the present invention.

FIG. 14 illustrates an isometric top view of an adapter according to an embodiment of the present invention.

FIG. 15 illustrates an isometric top view of a plurality of elongated pawl members and a spring latch assembly according to an embodiment of the present invention.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

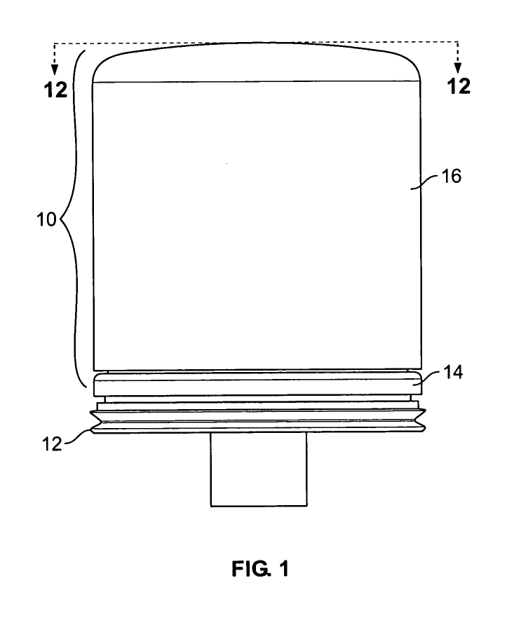

FIG. 1 illustrates a front view of a fluid filter assembly 10 secured to a mounting stud 12 of an engine according to an embodiment of the present invention. The fluid filter assembly 10 includes a first segment, such as a base or adapter 14 and a second segment, such as a filter refill, insert or module 16. The filter assembly 10 is configured to filter fluid, such as oil within an internal combustion engine. The filter assembly 10 is a two piece assembly in which the adapter 14 is configured to threadably secure to the mounting stud 12, while the filter module 16 is configured to be threadably or otherwise removably secured to the adapter 14, as discussed below.

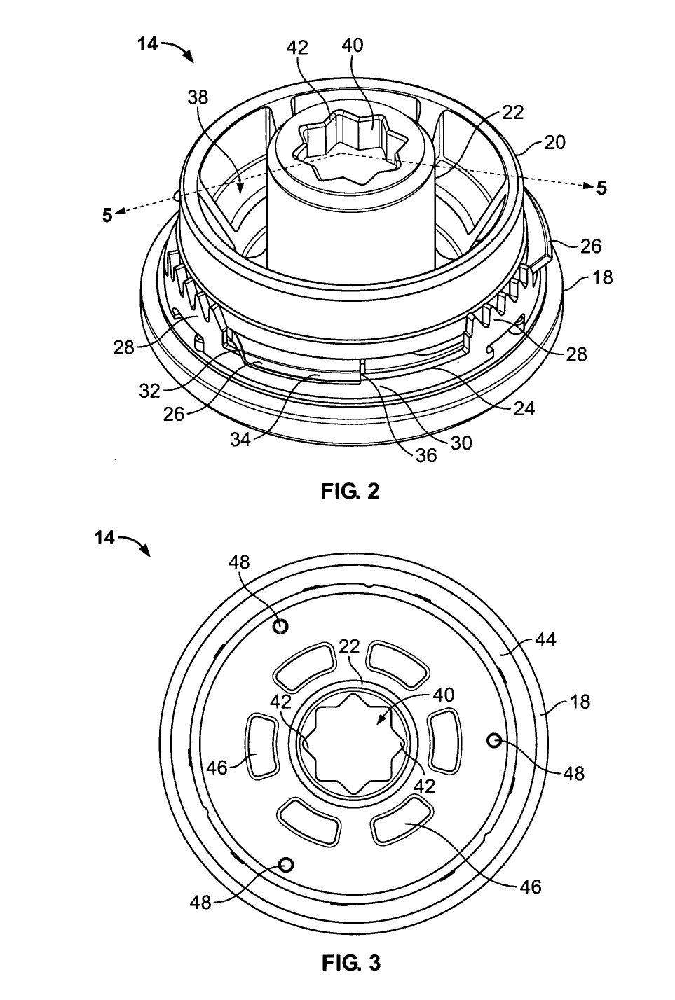

FIG. 2 illustrates an isometric top view of the adapter 14. The adapter 14 may be a metal, such as steel, an aluminum silicon alloy, or a nonmetallic material, and includes a generally circular base 18 integrally formed with an outer wall 20 and a fluid outlet tube 22. The base 18 supports a lower actuation ring 24 such that the lower actuation ring 24 may slidably rotate over the base 18. The lower actuation ring 24 is positioned on the outside of the outer wall 20 proximate the base 14. The lower actuation ring 24 is a generally circular structure having a plurality of upstanding teeth units 28 separated from one another at regular intervals by straight-edged walls 30.

Pawls 26, which extend outwardly from the outer wall 20, are positioned over the straight-edged walls 30. Each pawl 26 includes a ramped end 32 integrally formed with an intermediate portion 34 and a blunted straight end 36. Each ramped end 32 is proximate one of the teeth units 28. While two teeth units 28 and two pawls 26 are shown in FIG. 2, more or less teeth units 28 and pawls 26 than those shown may be used with the adapter 14.

A fluid inlet cavity 38 is defined between the outer walls 20 and the outlet tube 22. Unfiltered fluid passes into the fluid inlet cavity 38 from a source, such as an engine, and into the module 16 (shown in FIG. 1). A fluid outlet passage 40 is formed through the fluid outlet tube 22. Filtered fluid passes from the module (shown in FIG. 1) into the fluid outlet passage 40, and back into the source, such as the engine. The fluid outlet passage 40 is shown having a regular shape with a plurality of angled sides 42. The radial cross-section of the fluid outlet passage 40 is an 8 pointed star including two squares, in which one square is rotated forty-five degrees with respect to the other. The sides 42 are configured to receive distal ends of a tool, such as a ratchet, screwdriver, or the like, so that the adapter 14 may be secured and removed from the mounting stud 12 (shown in FIG. 1). That is, an operative end of a tool may grip the adapter through the angled sides 42. Alternatively, the radial cross-section of the fluid outlet passage 40 may be any shape, such as triangular, rectangular, or even circular.

FIG. 3 illustrates a bottom view of the adapter 14. A sealing gasket 44 is positioned underneath the base 18 and is configured to sealingly engage the mounting stud 12 (shown in FIG. 1). A plurality of fluid inlet passages 46 are formed through the base 18 around the fluid outlet tube 22. The fluid inlet passages 46 are unobstructed paths for fluid to pass through into the fluid inlet cavity 38 (shown in FIG. 2). Pawl anchor posts 48 extend upwardly from the base 18 (only the bottom surfaces of the posts 48 are shown in FIG. 3).

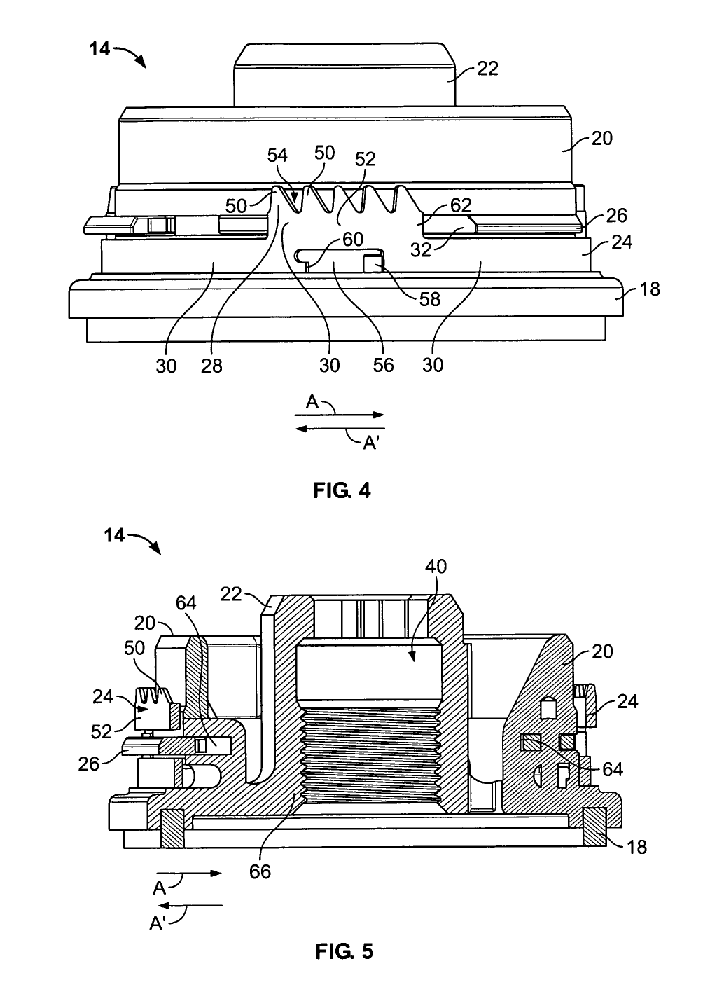

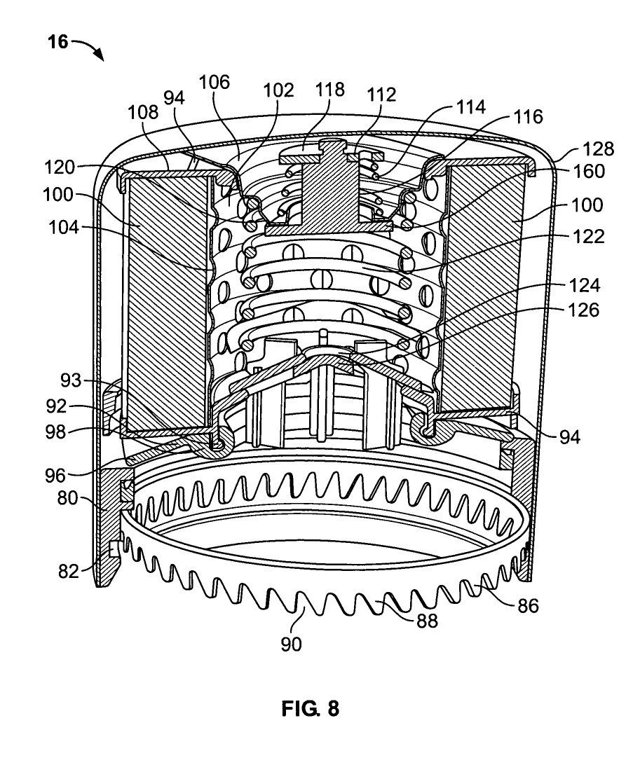

FIG. 4 illustrates a lateral view of the adapter 14. Each teeth unit 28 of the lower actuation ring 24 includes a plurality of teeth 50 integrally formed with a support 52. The support 52 is integrally formed with, and extends above, the straight edged walls 30. Adjacent teeth 50 are separated by gaps 54. As discussed below with respect to FIGS. 8-11, teeth of an actuation ring of the module 16 (shown in FIG. 1) are configured to mesh, interconnect, or otherwise mate with the teeth units 28 of the adapter 14. While the teeth units 28 are shown having sawteeth, each teeth unit 28 may, alternatively, be a block, tab, or arcuate unit having a plurality of upstanding members, such as blocks, tabs, clasps, curves, or the like, that may mate with reciprocal structures of the module 16 (shown in FIG. 1).

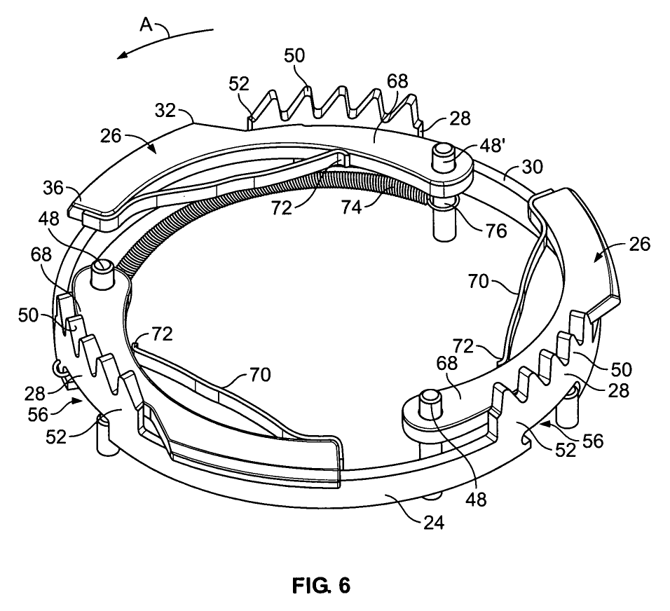

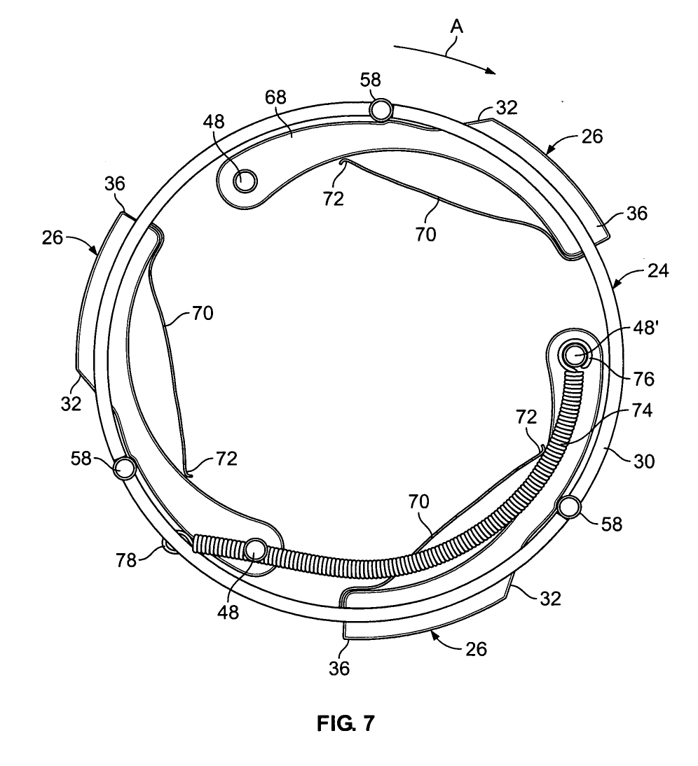

Underneath each teeth unit 28 is a clearance area 56. The clearance area 56 allows the lower actuation ring 24 to be moved in the direction of arrow A. A stop post 58 extends upwardly from the base 18 of the adapter 14 into the clearance gap 56. The stop post 58 limits the range of motion of the lower actuation ring 24 over the base 18. That is, when an edge 60 of the straight edge wall 30 is moved into abutment with the stop post 58, the lower actuation ring 24 can no longer be moved in the direction of arrow A. A spring member (discussed below with respect to FIGS. 6-7) assists in moving the actuation ring 24 in the direction of arrow A′ toward its original, or at-rest, position.

As the lower actuation ring 24 is moved in the direction of arrow A, front ends 62 of the supports 52 contact the ramped ends 32 of the pawls 26. As the lower actuation ring 24 continues to move in this direction, the supports 52 slide over the ramped ends 32, thereby urging the pawls 26 radially inward toward the fluid outlet tube 22. Thus, the actuation ring 24 may act as a camming mechanism with respect to the pawls 26.

As the lower actuation ring 24 is moved in the direction of arrow A′, either manually, or through the spring member (discussed below with respect to FIGS. 6-7), the supports 52 move away from the pawls 26. Thus, the pawls 26 are allowed to move radially outward to their original, or at-rest, positions as the supports 52 move away from the pawl 26. In particular, spring members (discussed below with respect to FIGS. 6-7) act to urge the pawls 26 back to their original positions, in which the pawls 26 outwardly extend from the outer wall 20.

Instead of pawls, various other resilient protuberances, or other such detents, may be used with the adapter 14. For example, the adapter 14 may include stiff wires, blocks, posts, semi-spherical or rounded buttons, spring-biased bumps, or the like, that may be urged radially inward by rotation of the lower actuation ring 24 and snap back to their original positions when the actuation ring 24 disengages from them.

For example, FIG. 15 illustrates an isometric top view of a plurality of elongated pawl members 200 and a spring latch assembly 202 according to an embodiment of the present invention. The pawl members 200 and the spring latch assembly 202 may be secured within the adapter 14 (shown, for example, in FIGS. 1-4) as described above. Each pawl member 200 includes an arcuate main body 204 integrally connected to an inwardly-curved latch engaging portion 206. The spring latch assembly 202 includes a generally cylindrical body 208 having spring arms 210 that exert a force into the inwardly-curved latch engaging portions 206.

FIG. 5 illustrates a cross-sectional view of the adapter 14 through line 5-5 of FIG. 2. As shown in FIG. 5, the pawls 26 are movably retained within notches 64 formed in the outer wall 20. Thus, each pawl 26 may be urged radially inward toward the fluid outlet tube 22 and subsequently radially away from the fluid outlet tube 22 through directions A and A′. That is, when the lower actuation ring 24 is rotated into the pawls 26, as noted above, the pawls 26 move radially inward toward the fluid outlet tube 22. Further, when the lower actuation ring 24 is moved away from the pawls 26, as noted above, the pawls move radially away from the fluid outlet tube 22.

FIG. 5 also shows that a lower interior portion 66 of the fluid outlet passage 40 is threaded. As such, the adapter 14 may be threadably secured to the mounting stud 12 (as shown in FIG. 1).

FIG. 6 illustrates an isometric top view of the lower actuation ring 24 and the pawls 26. FIG. 7 illustrates a bottom view of the lower actuation ring 24 and the pawls 26. For the sake of clarity, other components of the adapter 14 are not shown in FIGS. 6 and 7.

As shown in FIGS. 6 and 7, the pawls 26 are integrally formed with pivotable anchor members 68 that pivotally secure around the pawl anchor posts 48. Leaf springs 70 are secured to the blunted straight ends 36 of the pawls 26, and include free ends 72 that abut the anchor members 68. The leaf springs 70 exert an outwardly-directed force into the ends 36 of the pawls 26. Thus, the leaf springs 70 bias the pawls 26 outwardly from the outer wall 20. As the lower actuation ring 24 is rotated into the pawls 26, as discussed above, the force exerted by the leaf springs 70 into the ends 36 of the pawls 26 is overcome, thereby moving the pawls 26 inwardly by way of the anchor members 68 pivoting about the anchor posts 48. That is, the pawls 26 recede within the outer wall 20 (shown, for example, in FIGS. 5). During this time, the free ends 72 of the leaf springs 70 move over the anchor members 68 toward the anchor posts 48. As the actuation ring 24 moves out of contact with the pawls 26, the free ends 72 move away from the anchor posts 48 over the anchor members 68, thereby outwardly pushing the blunted straight ends 36 of the pawls 26. Thus, the pawls 26 move radially outward to their original positions by way of the anchor members 68 pivoting about the anchor posts 48 through the force exerted by the leaf springs 70. While leaf springs 70 are shown, various other types of force-exerting members may be used. For example, coil springs, latching spring assemblies, and the like may be used to exert force into the pawls 26.

As noted above, the adapter 14 (shown in FIGS. 1-5) includes a coil spring 74 having one end 76 secured around an anchor post 48′ and an opposite end 78 secured to the lower actuation ring 24. When the lower actuation ring 24 is moved in the direction of arrow A, the end 76 remains anchored to the anchor post 48′, while the end 78 moves along with the lower actuation ring 24. Thus, the coil spring 74 is stretched when the lower actuation ring 24 is moved in the direction of arrow A. When the actuation force is no longer applied to the lower actuation ring 24, the spring force built up through the stretching of the coil spring 74 tugs on the lower actuation ring 24, thereby moving the lower actuation ring 24 back to its original position (in which it does not contact the pawls 26). As the lower actuation ring 24 moves away from the pawls 26, the pawls 26 move radially outward to their original positions.

FIG. 8 illustrates a partial side cross-sectional view of the filter module 16. The filter module 16 includes a bottom ring or plate 80 having an annular notch 82 that is configured to snapably or otherwise removably retain the pawls (as discussed below). An actuation ring 86 is also retained by the bottom plate 80. For clarity, the actuation ring 86 is not shown in cross-section.

The actuation ring 86 includes a plurality of regularly spaced downwardly-extending teeth 88 separated by gaps 90. The teeth 88 are configured to mesh, interconnect, cooperate, or otherwise mate with the teeth units 28 of the lower actuation ring 24 (shown in FIGS. 2, and 4-7) of the adapter 14 (shown in FIGS. 1-5). That is, the teeth 88 mate into gaps 54 of the lower actuation ring 24, while the teeth 50 of the lower actuation ring mate into the gaps 90 of the actuation ring 86. Because the actuation ring 86 includes regularly-spaced teeth 88 over its entire circumference, the actuation ring 86 easily mates with the lower actuation ring 24 (without the need for a particular locating process). That is, because the lower actuation ring 24 includes a plurality of regularly spaced teeth units 28 (shown, for example, in FIG. 2), and the actuation ring 86 includes teeth 88 over its entire circumference, any portion of the actuation ring 86 may mate with the regularly spaced teeth units 28 of the adapter 14. Alternatively, the actuation ring 86 may include regularly-spaced teeth units separated by spaces, and/or the lower actuation ring 24 may include regularly-spaced upwardly-extending teeth over its entire circumference.

An anti-drain valve 92 is positioned above the bottom plate 80 and is secured to a lower end 93 of a filter support 94. The anti-drain valve 92 includes a flap 96 and a fixed end 98 secured to the lower end 93 of the filter support 94. The flap 96 sealingly engages a top surface of the bottom plate 80. As fluid enters the module 16, the fluid exerts a pressure into the flap 96, thereby urging the flap 96 away from the bottom plate 80, and allowing fluid to pass therethrough.

The filter end cap or support 94 supports a filter medium 100 around a central tube 102 having a plurality of holes 104 for filtered fluid to pass through. A pressure relief cap 106 is secured over the top end 108 of the filter support 94. A bypass valve or pressure relief plug 112 is positioned within the pressure relief cap 106. A coil spring 114 is positioned around a shaft 116 of the pressure relief plug 112 between a top cap 118 of the plug 112 and a base 120 of the pressure relief cap 106. The pressure relief plug 112 plugs a drain formed through the pressure relief cap 106. The shaft 116 of the pressure relief plug 112 is integrally formed with the top cap 118 and a lower cap 160 that is positioned below the pressure relief cap and covers the outlet of the drain (not shown) of the pressure relief cap 106. Fluid within the pressure relief cap 106 exerts a force into the lower cap 160. When the fluid pressure differential is great enough (for example, due to an excessive pressure drop across the filter medium 100), the force exerted into the lower cap 160 forces the pressure relief plug 112 open. That is, the lower cap 160 disengages from the drain or fluid outlet of the pressure relief cap 106 and fluid flows therethrough. At the same time, the spring 114 positioned between the top cap 118 and the portion of the pressure relief cap 106 around the fluid outlet compresses. The built-up energy in the spring 114 acts to move the pressure relief plug 112 back into engagement around the fluid outlet when fluid pressure exerted on the lower cap 160 decreases.

While the pressure relief plug 112 is shown with a coiled spring 114, various other types of pressure relief plugs or valves may be used with the oil filter assembly 10. For example, the bypass valve shown and described in U.S. application Ser. No. 11/033,566, filed Jan. 11, 2005, entitled “Oil Filter Assembly,” by Weinberger, et al. may be used in addition to, or in lieu of, the pressure relief plug 112 and the pressure relief cap 106. Additionally, the bypass or pressure relief valve shown and described in U.S. application Ser. No.______, filed Feb. 13, 2006, entitled “Pressure Relief Valve for Fluid Filter System,” by Weinberger et al. (Attorney Docket No. 17212US01), which is hereby incorporated by reference in its entirety, may also be used with embodiments of the present invention.

A coiled spring 122 is disposed between an underside of the relief cap 106 and a drip seal plug 124. While a hole is shown formed through the drip seal plug 124 in FIG. 8, there may not be a hole formed through the drip seal plug 124. The coil spring 122 exerts a force into the drip seal plug 124, thereby forcing the drip seal plug 124 into a fluid outlet member 126 of the lower end 93 of the filter support 94. The fluid outlet member 126 includes a plurality of openings that are sealed by the drip seal plug 124.

The module 16 also includes a cover or can 128 that covers the internal components of the module 16. The can 128 may be plastic, metal, or various other components capable of protecting and securing the internal components of the module 16.

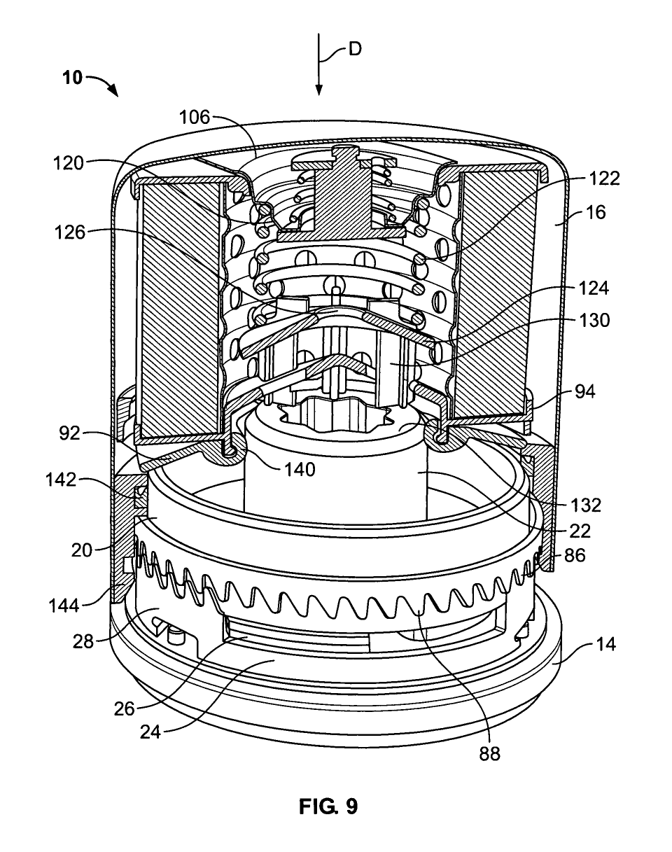

FIG. 9 illustrates the filter module 16 being initially mated with the adapter 14. The filter module 16 is urged into the adapter 14 in the direction of arrow D. During this stage, the teeth 88 of the actuation ring 86 of the module 16 begin to mesh, interconnect, or otherwise mate with the teeth units 28 of the lower actuation ring 24. Additionally, legs 130 of the drip seal plug 124 abut a top circumferential edge 132 of the fluid outlet tube 22. As the legs 130 abut the top edge 132, and the module 16 is further urged in the direction of arrow D, the drip seal plug 124 remains stationary relative to the top edge 132 (but moves relative to the filter module 16), while the fluid outlet member 126 of the filter support 94 continues to move downward relative to the top edge 132. Thus, the drip seal plug 124 moves out of sealing engagement with the fluid outlet member 126, and the coiled spring 122 compresses against the base 120 of the pressure relief cap 106. During this process, an inner diameter 140 of the anti-drain valve 92 sealingly slides over the fluid outlet tube 22 in the direction of arrow D, while an annular sealing member 142, such as a U cup seal, secured within the bottom plate 80 sealingly slides over the outer wall 20 of the adapter 14. Thus, the module 16 sealingly secures to the adapter 14 where the anti-drain valve 92 sealingly engages the fluid outlet tube 22, and where the annular sealing member 142 sealingly engages the outer wall 20.

As the module 16 is urged in the direction of arrow D, the pawls 26 engage the ramped lower edge 144 of the bottom plate 80. As the module 16 continues to move in the direction of arrow D, the ramped lower edge 144 forces the pawls 26 radially inward. That is, movement of the pawls 26 over the ramped lower edge 144 forces the pawls 26 to recede into the outer wall 20.

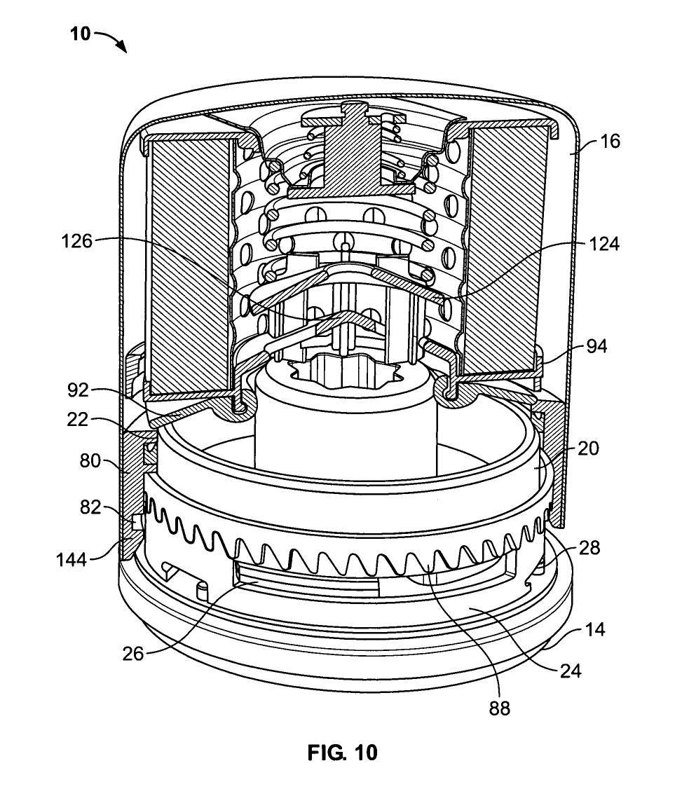

FIG. 10 illustrates the filter module 16 in a fully mated position with respect to the adapter 14. Once the pawls 26 slide past the ramped lower edge 144 of the module 16, the pawls 26 snap into the notch 82 of the bottom plate 80. In this fashion, the module 16 secures to the adapter 14. Also, as mentioned above, the anti-drain valve 92 sealingly engages the fluid outlet tube 22, while the sealing member 142 sealingly engages the outer wall 20.

Also, in this position, the teeth 88 of the actuation ring 86 are fully mated with the teeth units 28 of the lower actuation ring 24. Further, the drip seal plug 124 is disengaged from the fluid outlet member 126 of the filter support 94. As such, fluid may flow out of the fluid outlet member 126 into the fluid outlet tube 22.

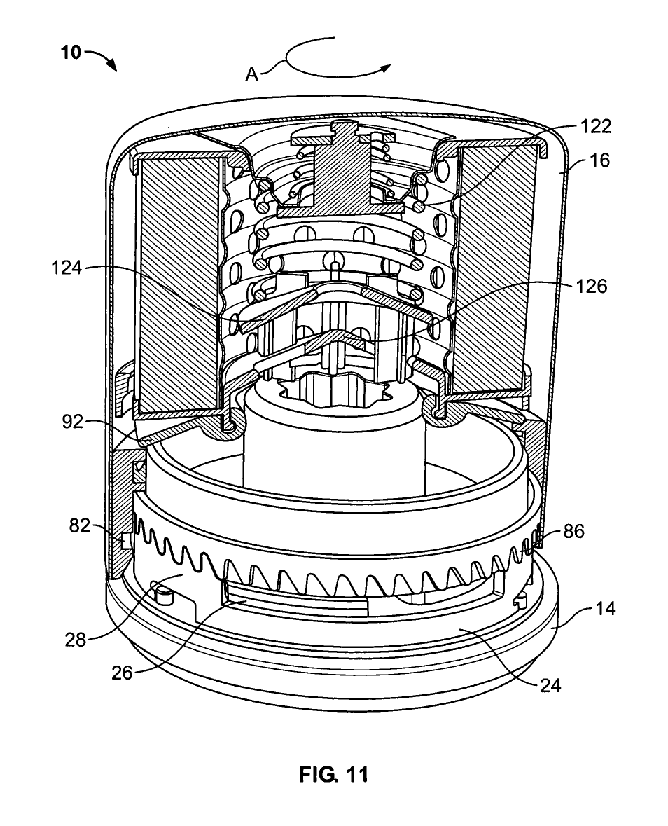

FIG. 11 illustrates the filter module 16 being disconnected from the adapter 14. In order to disconnect the filter module 16 from the adapter 14, the filter module 16 is rotated in the direction of arrow A. When the filter module 16 is rotated, the actuation ring 86, which is mated with the lower actuation ring 24 of the adapter 14, rotates the lower actuation ring 24 in the same direction. Movement of the lower actuation ring 24 in the direction of arrow A moves the pawls 26 radially inward, as discussed above with respect to FIGS. 4, and 6-7, for example. As the pawls 26 move radially inward, the pawls 26 move out of the notch 82. Consequently, the force built up in the spring 122 is exerted into the drip seal plug 124, thereby ejecting the filter module 16 from the adapter 14. At the same time, the drip seal plug 124 is forced back into a sealing engagement with the fluid outlet member 126. Thus, any fluid remaining in the module 16 is sealed inside the module 16 by the drip seal plug 124, and the anti-drain valve 92.

The filter module 16 and the adapter 14 may be configured to allow the module 16 to disconnect from the adapter at a variety of degrees of rotation. For example, the movement of the filter module 16 in the direction of arrow A may cause the pawls 26 to disengage from the notch 82 as discussed above through a fraction of a full turn. The distance of rotation for disconnecting the module 16 from the adapter 14 depends on the distance of the pawls 26 from the teeth units 28. Once the module 16 is disconnected from the adapter 14, the pawls snap back to their original positions as discussed above in FIGS. 4, and 6-7, for example.

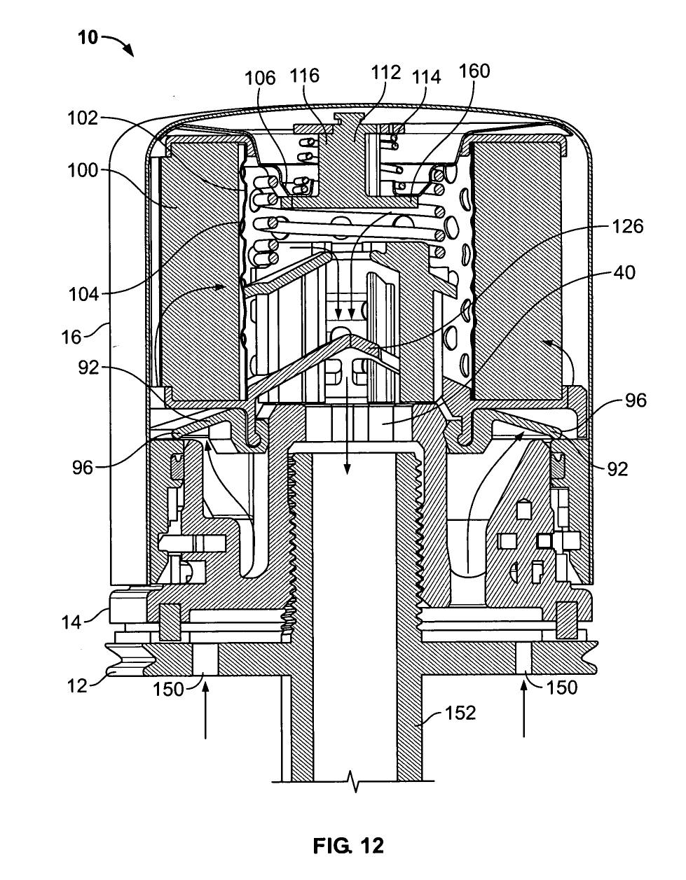

FIG. 12 illustrates a cross-sectional view of the oil filter assembly 10 secured to the mounting stud 12 through line 12-12 of FIG. 1. Unfiltered oil from a source, such as an engine, passes through outlets 150 of the mounting stud 12 into the adapter 14. The unfiltered oil then passes through the fluid inlet passages 46 (shown, for example, in FIG. 3) of the adapter 14. The pressure exerted by the unfiltered oil forces the flaps 96 of the anti-drain valve 92 open and the unfiltered oil passes into the filter medium 100. The filter medium 100 filters impurities from the unfiltered oil. The filtered oil then passes through holes 104 of the central tube 102 and through passages formed through the fluid outlet member 126. The filtered fluid then passes through the fluid outlet passage 40 of the adapter 14 and into a fluid inlet tube 152 of the mounting stud 12, which delivers the filtered fluid back to the source, such as an engine.

If, however, the filter medium 100 is clogged, or the oil is too viscous due to cold temperature, unfiltered fluid will flow around the filter medium 100 into the pressure relief cap 106. As unfiltered fluid congregates within the pressure relief cap 106, the fluid exerts a pressure into the lower cap 160 of the pressure relief plug 112, as discussed above with respect to FIG. 8. The pressure exerted by the fluid may be sufficient to unseat the lower cap 160 from the pressure relief cap 106, as discussed above.

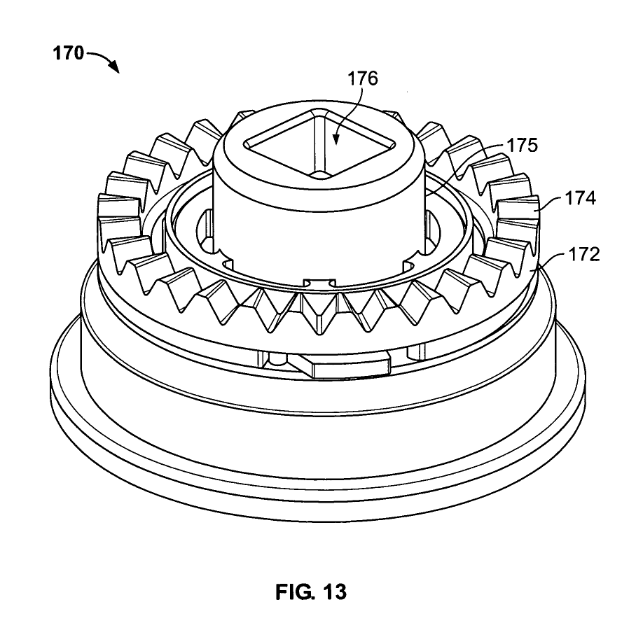

FIG. 13 illustrates an isometric top view of an adapter 170 according to an embodiment of the present invention. The adapter 170 includes an actuation ring 172 that includes regularly-spaced teeth 174 over the entire circumference of the actuation ring 172. Additionally, the adapter 170 includes a fluid outlet tube 175 having a square shaped fluid outlet passage 176. The adapter 170 may be used with the filter module 16 shown, for example, in FIGS. 1, and 8-12.

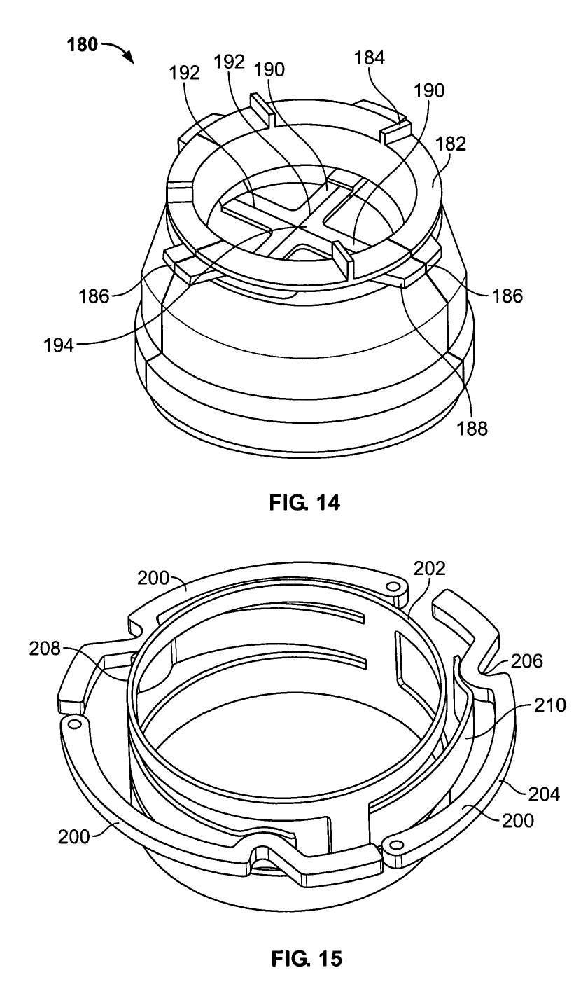

FIG. 14 illustrates an isometric top view of an adapter 180 according to an embodiment of the present invention. The adapter 180 includes an actuation ring 182 having a plurality of upwardly-extending tabs 184. The tabs 184 are configured to mate with reciprocal slots formed in an actuation ring (not shown) of a filter module (not shown).

Instead of the pawls 26, the adapter 180 includes a plurality of protuberances 186 having ramped surface 188. The actuation ring 182 may be actuated into the protuberances 186 similar to the actuation ring 24 (shown, for example, in FIGS. 2, and 4-7) actuating into the pawls 26 (shown, for example, in FIGS. 2, and 4-7) in order to move the protuberances 186 radially inward. Each protuberance 186 is integrally connected to a spring member 190 having a vertical beam (not shown) integrally connected to the protuberance 186, and a horizontal beam 192 integrally connected to the vertical beam. The horizontal beams 192 may connect at a central joint 194. When the actuation ring 182 moves into the protuberances 186, the protuberances 186 move radially inward, thereby inwardly flexing the vertical beams. Alternatively, the horizontal beams 192 may connect at a central ring having a central opening that allows fluid to pass unobstructed through a fluid outlet.

Thus, embodiments of the present invention provide a fluid filter assembly, such as an oil filter assembly, that is quick and easy to connect and disconnect from a fluid source, such as an engine. In general, embodiments of the present invention provide a system and method of quickly and efficiently changing a fluid filter. The filter module may be removed from the adapter by merely rotating the filter module relative to the adapter over a short distance. Once the old filter module, or insert, is removed, a new one may be connected to the adapter. Optionally, the oil filter module may be removed and the filter medium within the insert replaced. Then, the insert containing the new filter medium may be connected to the adapter.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A fluid filter system comprising:
a first segment comprising:
a filter medium;
a notch adapted to engage a detent; and
a first actuation member;
a second segment comprising:
a detent engageable with said notch to secure said first segment to said second segment, said detent being moveable between a locked position and an unlocked position; and
a second actuation member configured to cooperate with said first actuation member to move said detent into the unlocked position.

2. The fluid filter system of claim 1, wherein said first and second actuation members are configured to mate together, such that a rotation of said first actuation member will cause a corresponding rotation in said second actuation member, and said second actuation member is configured to contact said detent when said second actuation member is rotated, in order to move said detent into the unlocked position.

3. The fluid filter system of claim 1, wherein said first actuation member is a first circumferential actuation ring having a first set of teeth secured within said first segment.

4. The fluid filter system of claim 3, wherein said second actuation member is a second circumferential ring having a second set of teeth moveably secured to said second segment, wherein said first set of teeth mesh with said second set of teeth.

5. The fluid filter system of claim 4, wherein said second segment further comprises a coiled spring having one end secured to said second actuation member and another end fixedly secured within said second segment, said coiled spring tending to keep said second actuation member from contacting said detent.

6. The fluid filter system of claim 1, wherein said detent is at least one protuberance moveably secured within said second segment, said at least one protuberance extending outwardly from said second segment in the locked position, and said at least one protuberance receding into said second segment in the unlocked position.

7. The fluid filter system of claim 6, wherein said at least one protuberance is a pawl having a ramped end integrally formed with an intermediate section connected to a pivotable anchor member, said pivotable anchor member being pivotally secured within said second segment and allowing said pawl to pivot between the locked and unlocked positions.

8. The fluid filter system of claim 7, wherein said pawl further comprises a spring member that exerts an outwardly directed force into said pawl.

9. The fluid filter system of claim 1, further comprising at least one stop block that limits movement of said second actuation member.

10. The fluid filter system of claim 1, wherein at least one of said first and second segments further comprises a bypass valve.

11. The fluid filter system of claim 1, wherein said second segment further comprises a generally cylindrical base integrally formed with an outer wall and a fluid outlet tube, wherein a fluid inlet cavity is defined between said outer wall and said fluid outlet tube.

12. The fluid filter system of claim 11, wherein said first segment further comprises an anti-drain valve positioned proximate a fluid inlet, said anti-drain valve sealingly engaging said fluid outlet tube.

13. The fluid filter system of claim 11, wherein said first segment further comprises an annular seal member sealingly engaging said outer wall.

14. The fluid filter system of claim 1, wherein said first segment further comprises a spring-biased drip seal plug positioned proximate a fluid outlet.

15. The fluid filter system of claim 1, wherein said first segment disconnects from said second segment when said detent is in the unlocked position.

16. A method of disconnecting an oil filter module from an adapter secured to a mounting stud of an engine, the method comprising:
rotating the oil filter module relative to the adapter, wherein said rotating step comprises rotating a module actuation member fixed within the filter module;
causing an adapter actuation member movably secured within the adapter and mated to the module actuation member to rotate in response to said rotating the oil filter module step;
moving the adapter actuation member into contact with a detent that is retained by a notch to secure the filter module to the adapter;
disengaging the detent from the notch through said moving the adapter actuation member step; and
disconnecting the oil filter module from the adapter through said disengaging step, wherein said disconnecting step comprises removing the module actuation member from a mating position with the adapter actuation member.

17. The method of claim 16, wherein the adapter actuation member is mated to the module actuation member through interlocking teeth.

18. The method of claim 16, further comprising returning the detent to its original position after said disconnecting step.

19. The method of claim 16, further comprising sealing fluid orifices of the oil filter module during said disconnecting step.

20. A fluid filter system comprising:
a filter module comprising:
a filter medium;
a circumferential notch; and
a first actuation ring having a first set of teeth, wherein said first actuation ring is fixed within said filter module;
an adapter configured to secure to a mounting stud of a device, said adapter comprising:
a generally cylindrical base integrally formed with an outer wall and a fluid outlet tube, wherein a fluid inlet cavity is defined between said outer wall and said fluid outlet tube;
at least one pawl engageable with said notch to secure said filter module to said adapter, said at least one pawl being moveable between a locked position and an unlocked position, and being normally biased into said locked position, said at least one pawl extending outwardly from said outer wall in the locked position, and said at least one pawl receding into said outer wall in the unlocked position; and
a second actuation ring having a second set of teeth that mesh with said first set of teeth when said filter module is connected to said adapter, said second actuation ring being moveably secured within said adapter, said first and second actuation rings configured to cooperate to move said at least one pawl into the unlocked position, wherein said filter module is configured to disconnect from said adapter when said at least one pawl is in the unlocked position.

21. The fluid filter system of claim 20, wherein a rotation of said first actuation ring will cause a corresponding rotation in said second actuation ring, and said second actuation ring is configured to contact said at least one pawl when said second actuation ring is rotated, in order to move said at least one pawl into the unlocked position.

22. The fluid filter system of claim 20, wherein said adapter further comprises a coiled spring having one end secured to said second actuation ring and another end fixedly secured within said adapter, said coiled spring tending to keep said second actuation ring from contacting said at least one pawl.

23. The fluid filter system of claim 20, wherein said adapter further comprises at least one anchor post extending from said base, wherein said at least one pawl comprises a ramped end integrally formed with an intermediate section connected to a pivotable anchor member, said pivotable anchor member being pivotally secured to said at least one anchor post and allowing said second actuation ring to move said at least one pawl between the locked and unlocked positions.

24. The fluid filter system of claim 20, wherein said at least one pawl further comprises a spring member that exerts an outwardly directed force into said at least one pawl.

25. The fluid filter system of claim 20, further comprising at least one stop block that limits movement of said second actuation ring.

26. The fluid filter system of claim 20, wherein at least one of said filter module and said adapter further comprises a bypass valve.

27. The fluid filter system of claim 20, wherein said filter module further comprises an anti-drain valve positioned proximate a fluid inlet, said anti-drain valve sealingly engaging said fluid outlet tube.

28. The fluid filter system of claim 20, wherein said filter module further comprises an annular seal member sealingly engaging said outer wall.

29. The fluid filter system of claim 20, wherein said filter module further comprises a spring-biased drip seal plug positioned proximate a fluid outlet.
